(19) United States
(12) Patent Application Publication
(10) Pub. No.: US 2018/0277928 A1
(43) Pub. Date: Sep. 27, 2018

(54) TRIPLE MIMO ANTENNA ARRAY AND WIRELESS NETWORK ACCESS DEVICE

(71) Applicant: Xirrus, Inc., Thousand Oaks, CA (US)

(72) Inventor: Abraham Hartenstein, Chatsworth, CA (US)

(21) Appl. No.: 15/470,545

(22) Filed: Mar. 27, 2017

(51) Int. Cl. H01Q 1/24; H01Q 21/00; H01Q 1/48

(52) U.S. Cl. CPC H01Q 1/24; H01Q 1/48; H01Q 21/00

(57) ABSTRACT

There is disclosed antenna arrays and wireless network access devices. An antenna array includes a circuit card and three antenna element clusters, each antenna element cluster including three antenna elements extending from the circuit card.

### BACKGROUND

### Field

This disclosure relates to generally to wireless communication devices, and more particularly to antennas for wireless network access devices including Multiple-Input, Multiple-Output (MIMO) radios.

### Description of the Related Art

Smart phones, tablet computers, and other wireless communication devices are widely used for data networking. Data networks that use WiFi® (“Wireless Fidelity”), also known as “Wi-Fi,” are relatively easy to install, convenient to use, and supported by the Institute of Electrical and Electronic Engineers (IEEE) standard 802.11. The performance of WiFi data networks makes WiFi a suitable alternative to a wired data network for many business and home users.

WiFi networks operate by employing wireless access points that connect user devices (or client devices) in proximity to the access point to varying types of data networks such as, for example, an Ethernet network or the Internet. A wireless access point includes at least one radio that operates according to one or more of the standards specified in different sections of the IEEE 802.11 standard. Typically, wireless access points include omni-directional antennas that allow the radios within the access point to communicate with client devices in any direction. Each wireless access point is also connected to a data network such as the Internet through a backhaul communications link. The backhaul communication link is typically a hard-wired communication path such as an ethernet lick or a fiber optic link, but may also be a wireless communication path. User devices communicate with the data network via the wireless access point and the backhaul communications link.

The IEEE standards that define the radio configurations include:
A. IEEE 802.11a, which operates on the 5 GHz frequency band with data rates of up to 54 Mbs;
B. IEEE 802.11 b, which operates on the 2.4 GHz frequency band with data rates of up to 11 Mbs; and
C. IEEE 802.11g, which operates on the 2.4 GHz frequency band with data rates of up to 54 Mbs.
D. IEEE 802.11n, which operates on either the 2.4 GHz frequency band or the 5 GHz frequency band with increased data rates due to the use of multiple input/multiple output (MIMO) radios.
E. IEEE 802.11ac, which operates on the 5 GHz frequency band using MIMO radios with higher data rates than 802.11n.

Both the 2.4 GHz and 5 GHz frequency bands are divided into multiple frequency channels. For example, the 2.4 GHz band is divided into 14 defined frequency channels. Not all countries allow the use of all defined channels. Further, the frequency spacing between adjacent channels is only 5 MHz, which is smaller than the bandwidth required for WiFi communications. Thus only three or four non-overlapping channels are typically used at any particular location.

The use of MIMO radios in IEEE Standard 802.11n and 802.11ac results in higher data rates at the expense of requiring multiple antennas for reception and transmission at each radio. The need for multiple antennas complicates the physical design of wireless network access devices, particularly when the access devices include multiple MIMO radios.

### DESCRIPTION OF THE DRAWINGS

FIG. 1 is a block diagram of a wireless network access device including three MIMO radios.

FIG. 2 is a block diagram of a MIMO radio.

FIG. 3 is a perspective view of an antenna array for use with three 3×3 MIMO radios.

FIG. 4 is a top view of the antenna array of FIG. 3.

FIG. 5A is a top view of a dual-band monopole antenna element.

FIG. 5B is a side view of the dual-band monopole antenna element.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

Description of Apparatus

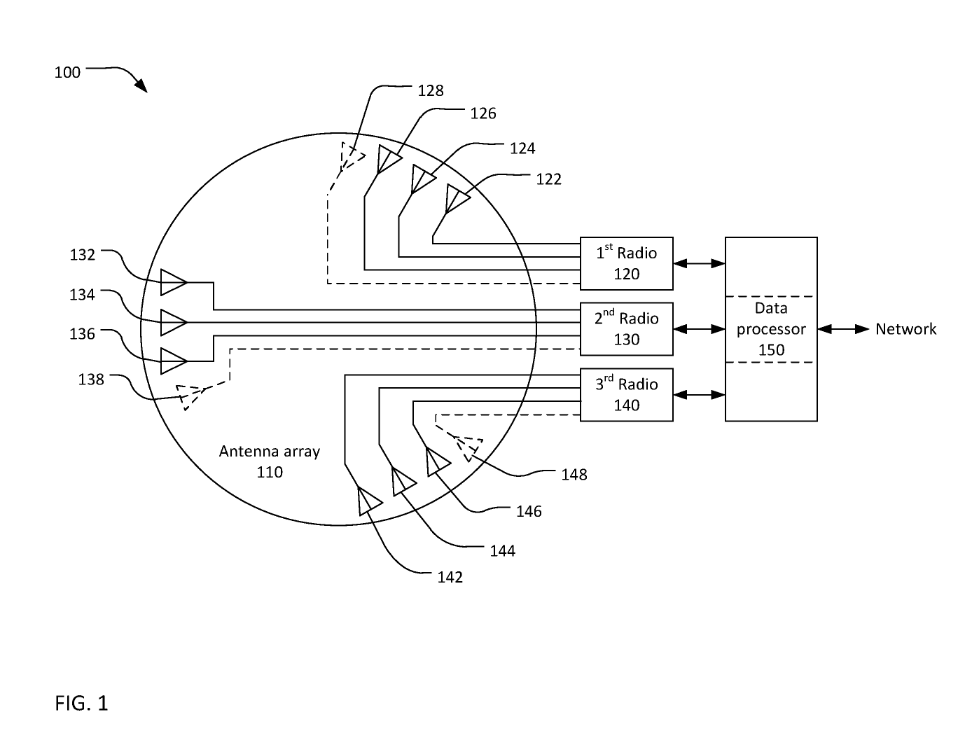

Referring now to FIG. 1, a wireless network access device 100 includes an antenna array 110; first, second, and third radios 120, 130, 140; and one or more data processor 150 within a common housing. Each radio 120, 130, 140 may be a 3×3 MIMO radio or, optionally, a 4×4 MIMO radio. Each 3×3 MIMO radio is coupled to three antenna elements of the antenna array 110. Each 4×4 MIMO radio is coupled to four antenna elements of the antenna array 110. For example, the first radio 120 is coupled to elements 122, 124, 126, and optionally 128 of the antenna array 110. Similarly, the second radio 130 is coupled to antenna elements 132, 134, 136 and optionally 138, and the third radio 140 is coupled to antenna elements 142, 144, 146, and optionally 148. The optional antenna elements and connections are shown in FIG. 1 using dashed lines.

Within this patent, the term “channel” means a subdivision of a frequency band, and the term “stream” means the bidirectional signal flow between a radio and an antenna. Radios 120, 130, 140 each transmit and/or receive three or four streams via the respective three or four antenna elements. All three streams of each radio 120, 130, 140 use the same frequency channel. Typically, the three radios 120, 130, 140 operate at different frequency channels which may or may not be within the same frequency band.

The data processor 150 performs or provides functions to bidrectionally transfer data between the three radios 120, 130, 140 and a network. The data processor 150 includes interfaces for exchanging frames and other data with the radios 120, 130, 140, and for exchanging frames and other data with the network. The data processor 150 may include multiple interfaces to the network and/or the radios 120, 130, 140 with failover support between interfaces. Data to/from each radio 120, 130, 140 may be transferred to the network via shared or individual wired, fiber-optic, or wireless communication paths. The network may be, for example, a local area network or a wide area network which may be or include the Internet, or some other network. Preferably, the data processor 150 transfers data between the radios 120, 130, 140 and the network via a high-speed communications path. For example, the data processor 150 may communicate with the network via a 10 Mbs (megabits per second), 100 Mbs, 1 Gbs (gigabits per second), 2.5 Gbs, 5 Gbs or 10 Gbs Ethernet interface.

The data processor 150 may provide some or all IEEE 802.11 media access control (MAC) services for the radios 120, 130, 140. To this end, the data processor 150 may include receiver and transmitter queues for the network interface and each radio 120, 130, 140, and a queue controller to manage the flow of data frames entering and exiting the queues. The data processor may perform other functions and services.

The functions and services provided by the data processor 150 may be implemented by software running on a suitable processor, by hardware that may include one or more application specific integrated circuits (ASIC) and/or one or more field programmable gate arrays, or by a combination of hardware and software. All, some, or none of the functions and services provided by the data processor 150 may implemented by common hardware (or a common processor) shared between the three radios 120, 130, 140.

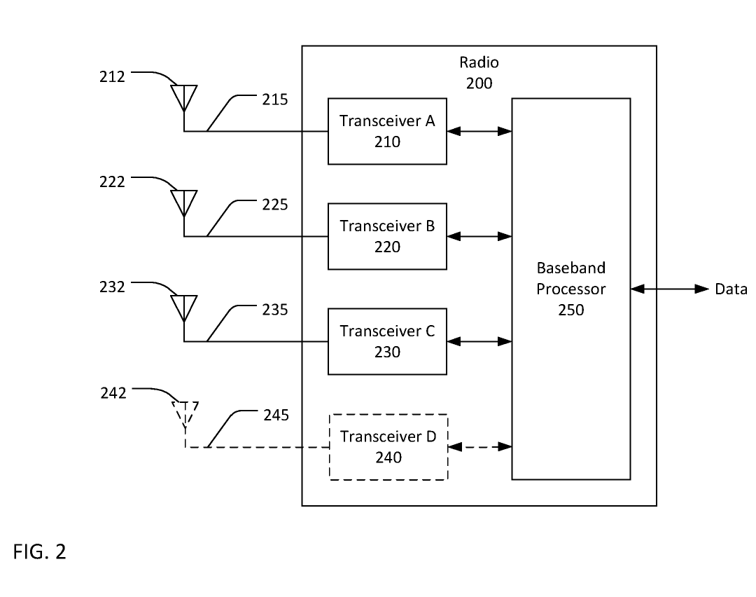

All, some, or none of the functions and services provided by the data processor 150 may implemented by unique hardware (or unique processors) dedicated to individual radios. FIG. 2 is a block diagram of a radio 200 which may be suitable for use as the radios 120, 130, 140 of the wireless network access device 100. The radio 200 may be a 3×3 MIMO radio including three transceivers 210, 220, 230 and a baseband processor 250. The radio 200 may be a 4×4 MIMO radio including an additional transceiver 240. Each of the three or four transceivers sends and receives respective streams 215, 225, 235, 245 via respective antennas 212, 222, 232, 242. Each antenna 212, 222, 232, 242 (when presented) is connected to a corresponding transceiver 210, 220, 230, 240 within the three-stream radio 200. The transceivers 210, 220, 230, 240 process signals received at the corresponding antennas 212, 222, 232, 242 to extract a baseband signal. The transceivers 210, 220, 230, 240 also modulate the baseband signals received from the baseband processor 250 for transmission via the antennas 212, 222, 232, 242. The baseband processor 250 processes the baseband signals being sent or received by the radio 200. The baseband processor 250 may perform other functions, such as providing some or all IEEE 802.11 media access control (MAC) services for the radios

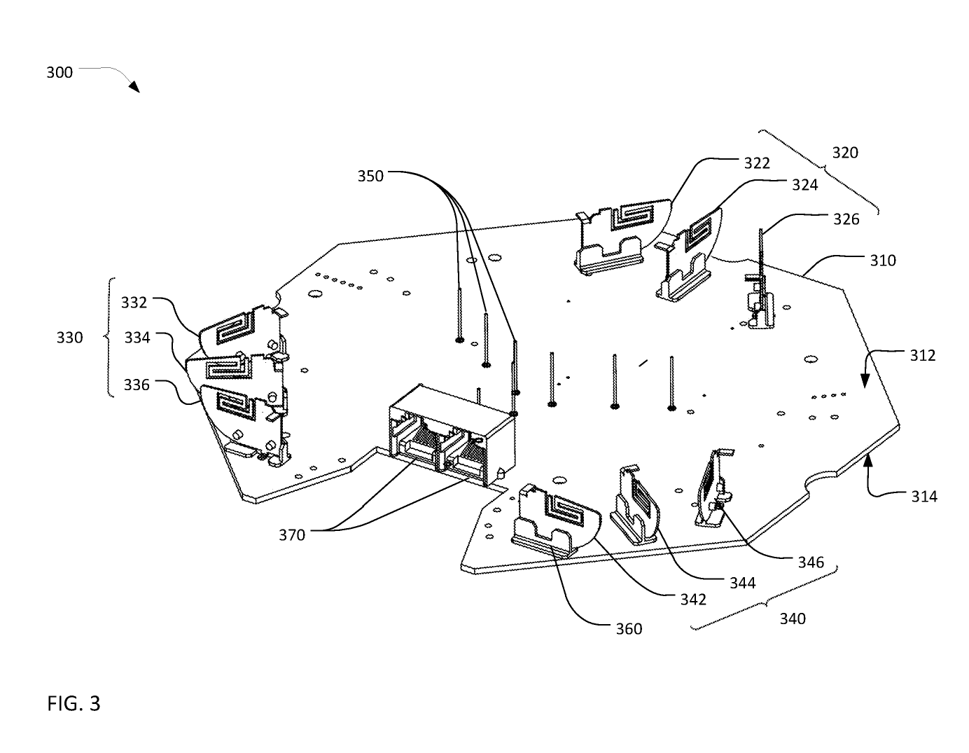

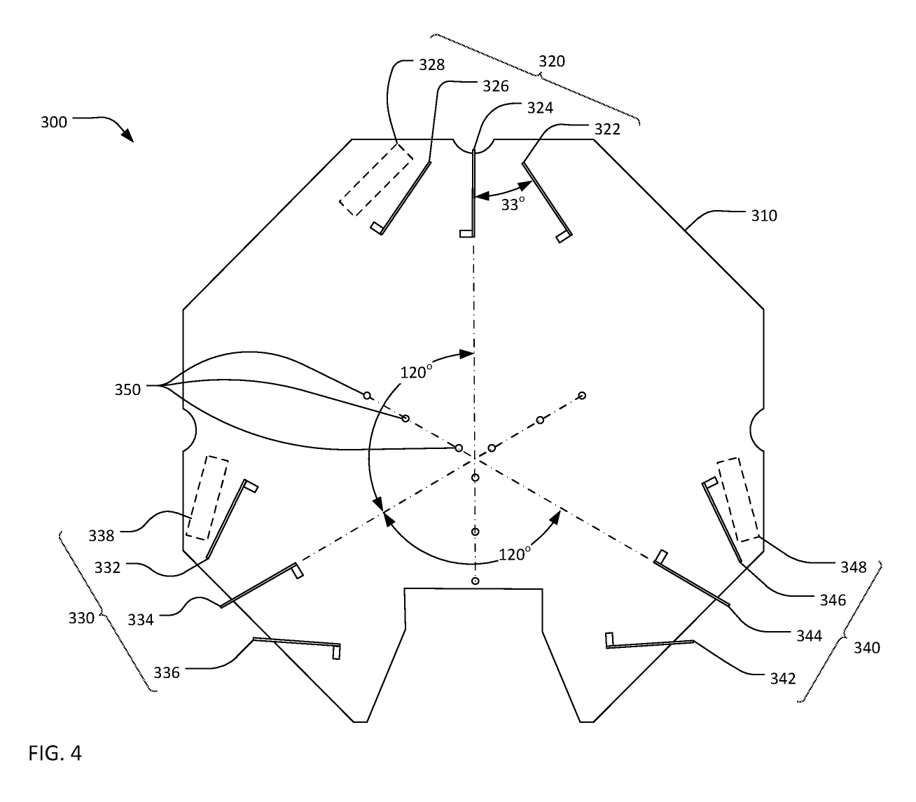

FIG. 3 is a perspective view of an antenna array 300 suitable for use as the antenna array 110 in the wireless network access device 100. FIG. 4 is a top view of the antenna array 300. The term “top view” refers to the position of the antenna array 300 as shown in FIG. 3. However, the antenna array 300 may be used in various positions such as upside down. For example, a wireless network access device containing the antenna array 300 may commonly, but not necessarily, be mounted on a ceiling with the antenna elements extending downward.

The antenna array 300 includes a circuit board 310, a first antenna element cluster 320 including at least three antenna elements 322, 324, 326, a second antenna element cluster 330 including at least three antenna elements 332, 334, 336, and a third antenna element cluster 340 including at least three antenna elements 342, 344, 346. “Cluster” is used here with its normal meaning of “a number of similar things grouped together in association or in physical proximity.” In this case, the antenna elements in each antenna element cluster are substantially closer to each other than to the other clusters. Specifically, the distance between the center antenna elements of two different antenna element clusters may be at least three times the distance between adjacent antenna elements within an antenna element cluster. The separation between adjacent antenna elements in each antenna element cluster may be, for example, one-half to one wavelength at the 5 GHz WiFi band. Some or all of the three antenna element clusters 320, 330, 340 may include respective fourth antenna elements 328, 338, 348.

The three antenna element clusters 320, 330, 340 may be distributed about a perimeter of the circuit board 310. For example, the antenna elements 322, 324, 326, 332, 334, 336, 342, 344, 346 may form a roughly circular array of antenna elements, with the center antenna elements for each cluster (i.e. antenna elements 324, 334, 344) disposed at approximately 120 degree intervals around the circumference of the circular array. In the absence of other description, the term “approximately” means “equal to a stated value within 20%”. Alternatively, the antenna elements 324, 334, 344 may be considered as disposed at the vertices of an equilateral, or approximately equilateral, triangle. The three antenna element cluster 320, 330, 340 may be disposed around the perimeter of the circuit board 310 with approximately equal spacing between adjacent clusters.

The circuit board 310 may be a double-sided or multilayer circuit board. A conductive ground plane may cover some, most, or nearly all of a first side 312 of the circuit board 310 on which the antenna elements are mounted. When the antenna array 300 is incorporated into a wireless network access device, components for radios, processors, and other portions of the access device may be mounted on the first side 312 and/or a second side 314 of the circuit board 310 (not visible in FIG. 3 or FIG. 4). For example, FIG. 3 shows connectors 370 mounted on the first side 312 of the circuit board 310. These components and the nine antenna elements may be interconnected by circuit traces on the first side 312, the second side 314, and/or internal layers of the circuit board 310.

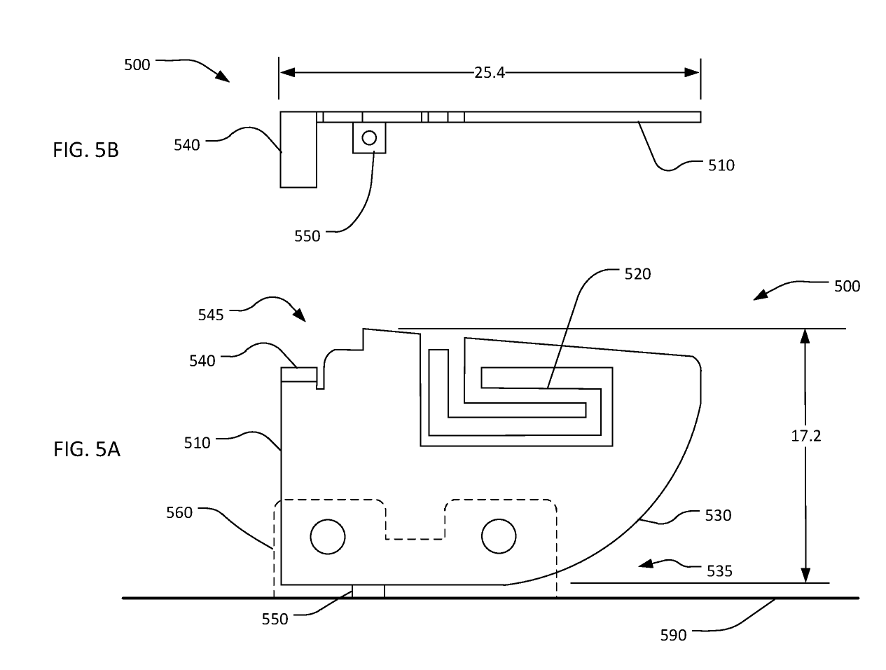

Each of the nine antenna elements 322, 324, 326, 332, 334,336, 342, 344, 346 may be a dual-band monopole antenna extending from the circuit board 310. Each dual-band monopole antenna may be configured for operation in both the 2.4 GHz and 5 GHz frequency bands. FIG. 5A and FIG.5B are side and top views, respectively, of a suitable dual-band monopole antenna element 500. The antenna element 500 may be cut from thin sheet metal, such as brass or copper. Alternatively, the antenna element 500 may be formed by patterning a conductive layer on a printed wiring board or other dielectric substrate. The antenna element 500 is typically mounted extending perpendicularly from a printed wiring board 590. When the antenna element 500 is cut from thin sheet metal, a tab 550 may be bent at a 90-degree angle to provide a contact to a trace on the printed wiring board. The antenna element 500 may optionally be supported by a dielectric bracket 560 attached to the printed wiring board 590.

The antenna element 500 may be roughly rectangular in shape with a width of about 25.4 mm and a height of about 17.2 mm (the terms “height” and “width” refer to the antenna element as oriented in FIG. 5A). One portion of the antenna element 500 adjacent the printed wiring board 590 may be formed as a convex curve 530 that, in conjunction with a ground plane on the printed wiring board 590, acts as a tapered slot antenna 535 having a broad bandwidth that includes the 5 GHz WiFi band. Another portion of the antenna element may be formed into a folded stub 520 that creates a resonance at the 2.4 GHz WiFi band. The antenna element 500 may have features, such as the tab 540 and notched corner 545, to facilitate handling by automated manufacturing equipment. Such features may have little or no effect on the performance of the antenna element 500.

Referring back to FIG. 3 and FIG. 4, the three dual-band monopole antennas in each antenna element cluster 320, 330, 340 may be parallel to each other. The three dual-band monopole antennas in each antenna element cluster 320, 330, 340 may be tilted with respect to each other by an angle such as 33 degrees, as shown in the embodiment of FIG. 3 and FIG. 4.

When present, the fourth antenna elements 328, 338, 348 in the three antenna element clusters 320, 330, 340 may be printed monopole antennas formed on one or both surfaces of the circuit board 310. Possible locations of the fourth antenna elements 328, 338, 348 are indicated by the dashed rectangles in FIG. 4. Any of several known printed dual-band monopole antenna designs may be used for the fourth antenna elements 328, 338, 348. The antenna array 300 is typically mounted on a ceiling with the antenna elements extending downward from the circuit card. In this configuration, the gain of each antenna cluster may be 4 dBi to 6 dBi (dB isotropic, which is the gain in dB relative to a theoretical isotropic antenna) in the 5 GHz band and 0 dBi to 1 dBi in the 2.4 GHz band. The azimuth coverage of each antenna cluster is nearly 360 degrees, with some dropouts or directions having significantly reduced gain.

A potential problem in multiple-radio wireless network access devices is transmissions from one radio interfering with reception by a second radio even though the two radios are operating in different frequency channels. A typical requirement for multiple-radio wireless network access devices is that the transmissions from one radio must be attenuated by about 40 dB at the antenna(s) of each other radio. This attenuation must be caused by the physical structure of the antenna array within the wireless network access device. An additional 40 dB to 50 dB of isolation may be provided by the frequency selectivity of each radio. The dual-band monopole antenna elements and printed monopole antenna elements of the antenna array 300 are directional, such that most radiated power is directed away from the circuit card. Since the radiated power level tangential to the circuit card is low, the inherent isolation between the antennas in different clusters may be about 30 dB. To ensure the transmissions from one antenna element cluster are attenuated by at about 40 dB at the antenna(s) of the other antenna element clusters, a fence consisting of a plurality of grounded pins 350 may be disposed between the three antenna element clusters 320, 330, 340. In the example of FIG. 3 and FIG. 4, a total of nine grounded pins 350 extend from the circuit card 310, with three pins positioned between each pair of antenna element clusters. Each pin may be connected to a ground plane in the circuit card 300. The length of each pin may be, for example, one-quarter of a wavelength at the 5 GHz WiFi band.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. Elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of” , respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

1. An antenna array comprising:
a circuit card;
three antenna element clusters, each antenna element cluster comprising three antenna elements extending from the circuit card; and
a plurality of grounded pins extending from the circuit card between the three antenna element clusters.

2. The antenna array of claim 1, wherein:
the three antenna element clusters are distributed at approximately equal intervals around a perimeter of the circuit card.

3. The antenna array of claim 2, wherein
a distance between center antenna elements of two different antenna element clusters is at least three times a distance between adjacent antenna elements within the same antenna element cluster.

4. (canceled)

5. The antenna array of claim 1, wherein:
the plurality of grounded pins comprises at least nine grounded pins, with at least three ground pins disposed between each pair of the three antenna element clusters.

6. The antenna array of claim 1, wherein:
each of the plurality of grounded pins extends from the circuit card for a distance equal to or greater than approximately 0.25 wavelength at a frequency of operation.

7. The antenna array of claim 1, wherein:
each of the antenna elements extending from the circuit card is a dual-band monopole antenna element.

8. The antenna array of claim 1, wherein:
Within each antenna element cluster, the antenna elements extending from the circuit card are separated by 0.5 to 1.0 wavelengths at a frequency of operation.

9. The antenna array of claim 1, wherein:
one or more of the three antenna element clusters further comprises a fourth antenna element formed on one or both surfaces of the circuit card.

10. A wireless network access device, comprising:
three multiple-input multiple-output (MIMO) radios; and
an antenna array comprising:
a circuit card;
three antenna element clusters, each antenna element cluster comprising three antenna elements extending from the circuit card; and
a plurality of grounded pins extending from the circuit card between the three antenna element clusters,
wherein each of the three MIMO radios is connected to a respective one of the three antenna element clusters.

11. The wireless network access device of claim 10, wherein
each MIMO radio comprises three transceivers, each transceiver connected to a respective one of the three antenna elements extending from the circuit card of the respective antenna element cluster.

12. The wireless network access device of claim 10, wherein
one or more of the three antenna element clusters further comprises a fourth antenna element formed on one or both surfaces of the circuit card, and
one or more of the MIMO radios further comprises a fourth transceiver connected to the fourth antenna element of the respective antenna element cluster.

13. The wireless network access device of claim 10, wherein:
the plurality of grounded pins comprises at least nine grounded pins, with at least three ground pins disposed between each pair of the three antenna element clusters.

14. The wireless network access device of claim 10, wherein:
each of the plurality of grounded pins extends from the circuit card for a distance equal to or greater than approximately 0.25 wavelength at a frequency of operation.

15. The antenna array of claim 1, wherein
the grounded pins extend perpendicularly from the circuit card.

16. The wireless network access device of claim 10, wherein
the grounded pins extend perpendicularly from the circuit card.
